(19) United States
(12) Patent Application Publication
(10) Pub. No.: US 2013/0296391 A1
(43) Pub. Date: Nov. 7, 2013

(54) PLANT DISEASE CONTROLLING COMPOSITION AND METHOD FOR CONTROLLING PLANT DISEASE

(71) Applicants: So Kiguchi, Takarazuka-shi (JP); Soichi Tanaka, Takarazuka-shi (JP)

(72) Inventors: So Kiguchi, Takarazuka-shi (JP); Soichi Tanaka, Takarazuka-shi (JP)

(73) Assignee: SUMITOMO CHEMICAL COMPANY, LIMITED, Tokyo (JP)

(21) Appl. No.: 13/822,999

(22) PCT Filed: Oct. 5, 2011
(86) PCT No.: PCT/JP11/73463

§ 371 Date: Mar. 18, 2013

(30) Foreign Application Priority Data
Oct. 7, 2010 (JP) 2010-227399
Mar. 8, 2011 (JP) 2011-049971

(51) Int. Cl. A01N 37/18; A01N 43/52

(52) U.S. Cl. CPC A01N 37/18; A01N 43/52
USPC 514/394

(57) ABSTRACT

The present invention provides a composition having an excellent controlling activity on a plant disease. The composition comprising a compound represented by Formula (1) and one or more fungicidal compound(s) selected from Group (A) shows an excellent controlling activity on a plant disease. Group (A): a group consisting of benomyl and carbendazim

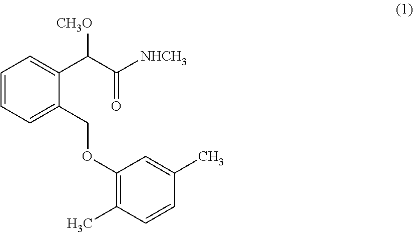

### TECHNICAL FIELD

The present invention relates to a plant disease controlling composition and a method for controlling a plant disease.

### BACKGROUND ART

Hitherto, there has been provided compounds as an active ingredient for a composition for controlling a plant disease (see e.g., The Pesticide Manual—15th edition (BCPC published) ISBN 1901396188).

Also there has been provided a compound of Formula (1):

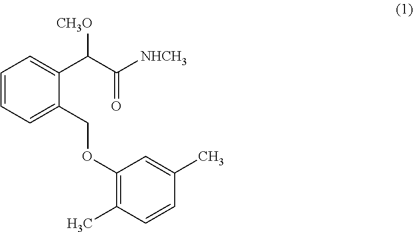

(see e.g., WO 95/27693 pamphlet and WO 02/10101 pamphlet).

### DISCLOSURE OF INVENTION

An object of the present invention is to provide a composition having an excellent control effect on a plant disease.

The present inventors have intensively studied to find out a composition having an excellent control effect on a plant disease. As a result, they have found that a composition comprising the compound represented by Formula (1) and one or more fungicidal compound selected from the following group (A) shows a synergistic activity, and thus has an excellent control effect on a plant disease, and therefore the present invention has been completed.

The present invention provides:

[1] A plant disease controlling composition comprising a compound represented by Formula (1):

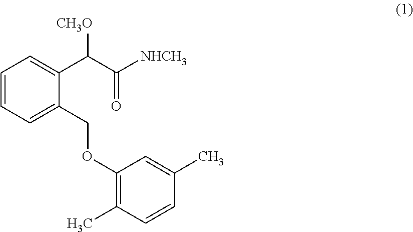

and one or more fungicidal compound(S) selected from Group (A):
Group (A): a group consisting of benomyl and carbendazim.
[2] The plant disease controlling composition according to the above [1], wherein the weight ratio of the compound represented by Formula (1) to the fungicidal compound(s) is from 0.0125/1 to 500/1.
[3] The plant disease controlling composition according to the above [1] or [2], wherein the compound represented by Formula (1) has R-absolute configuration.
[4] A method for controlling a plant disease, wherein the method comprises applying an effective amount in total of a compound of Formula (1):

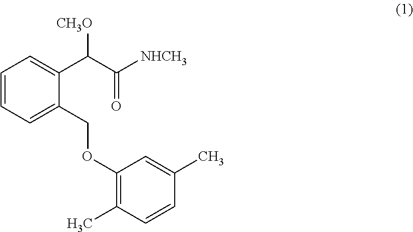

and one or more fungicidal compound(s) selected from Group (A) to a plant or a soil for cultivating the plant,
Group (A): a group consisting of benomyl and carbendazim.
[5] The method according to the above [4], wherein the compound of Formula (1) and the fungicidal compound(s) are applied to a seed.
[6] The method according to the above [4] or [5], wherein the weight ratio of the compound represented by Formula (1) to the fungicidal compound(s) is from 0.0125/1 to 500/1.
[7] The method according to any one of the above [4] to [6], wherein the compound represented by Formula (1) has R-absolute configuration.
[8] Use of a combination of a compound represented by Formula (1):

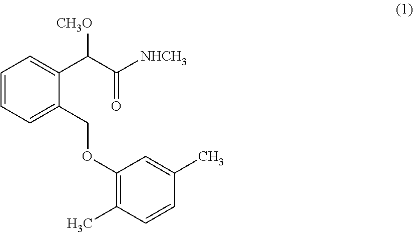

and one or more fungicidal compound(s) selected from Group (A) for controlling a plant disease,
Group (A): a group consisting of benomyl and carbendazim.

The present invention enables to control a plant disease.

### MODE FOR CARRYING OUT THE INVENTION

A plant disease controlling composition of the present invention (hereinafter, referred to as a composition of the present invention) comprises a compound represented by Formula (1):

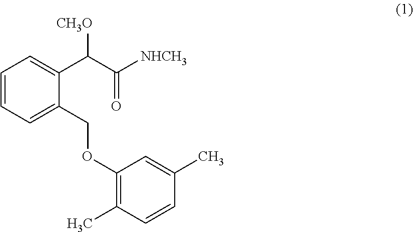

(hereinafter, referred to as an amide compound of the present invention) and one or more compound(s) selected from Group (A) (hereinafter, referred to as a fungicidal compound of the present invention),
Group (A): a group consisting of benomyl and carbendazim.

The present amide compound is described in for example, WO 95/27693 pamphlet and WO 02/10101 pamphlet, and thus can be prepared according to the method described therein.

The present amide compound has one asymmetric carbon. Herein, a compound represented by Formula (1) wherein an enantiomer having R-absolute configuration is enriched is referred to as an amide compound having R-absolute configuration.

The present amide compound encompasses the following compounds:

compounds represented by Formula (1) wherein an enantiomer having R-absolute configuration amounts to 70% and more of the total amount thereof;

compounds represented by Formula (1) wherein an enantiomer having R-absolute configuration amounts to 90% and more of the total amount thereof;

compounds represented by Formula (1) wherein an enantiomer having R-absolute configuration amounts to 95% and more of the total amount thereof.

Benomyl and carbendazim to be used in the present invention are known compounds, which are described in for example, “The PESTICIDE MANUAL—15th EDITION (BCPC published) ISBN 1901396188”, pages 85 and 158 respectively. These compounds are either commercially available, or can be prepared by a known method.

The weight ratio of the present amide compound to the present fungicidal compound(s) in the composition of the present invention is usually from 0.0125/1 to 500/1 (the present amide compound/the present fungicidal compound(s)), preferably 0.025/1 to 100/1, and more preferably 0.1/1 to 10/1.

Although the composition of the present invention may be a mixture as itself of the present amide compound and the present fungicidal compound(s), the composition of the present invention is usually prepared by mixing the present amide compound, the present fungicidal compound(s) and an inert carrier, and if necessary, adding a surfactant or other pharmaceutical additives, and then formulating into the form of oil solution, emulsifiable concentrate, flowable formulation, wettable powder, granulated wettable powder, dust formulation, granules and so on. Such formulations can be used by itself or with an addition of other inert components as an agent for controlling a plant disease.

Usually, the composition of the present invention can contain 0.1 to 99% by weight, preferably 0.2 to 90% by weight, and more preferably 1 to 80% by weight of the present amide compound and the present fungicidal compound(s) in total.

Examples of a solid carrier used on the formulation include finely-divided powder or particles of clay consisting of minerals (e.g., kaolin clay, attapulgite clay, bentonite, montmorillonite, acid clay, pyrophyllite, talc, diatomaceous earth, or calcite), natural organic substances (e.g., corncob powder, or walnut shell powder), synthetic organic substances (e.g., urea), salts (e.g., calcium carbonate, or ammonium sulfate), synthetic inorganic substances (e.g., synthetic hydrous silicon oxide) and so on. Examples of a liquid carrier include aromatic hydrocarbons (e.g., xylene, alkyl benzene, or methylnaphtalene), alcohols (e.g., 2-propanol, ethylene glycol, propylene glycol, or ethylene glycol monoethyl ether), ketones (e.g., acetone, cyclohexanone, or isophorone), vegetable oils (e.g., soybean oil, or cotton oils), petroleum-derived aliphatic hydrocarbons, esters, dimethylsulfoxide, acetonitrile and water.

Examples of the surfactant include anionic surfactant (e.g., alkyl sulfate salts, alkylaryl sulfate salts, dialkyl sulfosuccinate salts, polyoxyethylene alkylaryl ether phosphates, lignin sulfonate, or naphthalenesulfonate formaldehyde polycondensation), nonionic surfactant (e.g., polyoxyethylene alkylaryl ether, polyoxyethylene alkyl polyoxypropylene block copolymer, or sorbitan fatty acid ester) and cationic surfactant (e.g., alkyltrimethyl ammonium salts).

Examples of the other pharmaceutical additives include water-soluble polymer (e.g., polyvinyl alcohol, or polyvinyl pyrrolidone), polysaccharides (e.g. arabic gum, alginic acid and salts thereof, CMC (carboxymethyl-cellulose), or xanthan gum), inorganic substances (e.g., aluminum magnesium silicate, or alumina-sol), antiseptic agent, coloring agent, and PAP (isopropyl acid phosphate), and stabilizing agent (e.g., BHT).

The composition of the present invention can also be prepared by separately formulating the present amide compound and the present fungicidal compound(s) into different formulations by the above procedures, if necessary, further diluting each of them with water, thereafter, mixing the separately prepared different formulations or the dilute solutions.

The composition of the present invention may further contain one or more other fungicide(s) and/or insecticide(s).

The composition of the present invention is used to control a plant disease by applying it to a plant or a soil for cultivating the plant.

The plant diseases which can be controlled by the present invention are exemplified below:

Rice diseases: blast (Magnaporthe oryzae), helminthosporium leaf spot (Cochliobolus miyabeanus), sheath blight (Rhizoctonia solani) and bakanae disease (Gibberella fujikuroi);

Diseases of barley, wheat, oats and rye: powdery mildew (Erysiphe graminis), Fusarium head blight (Fusarium graminearum, F. avenaceum, F. culmorum, F. asiaticum, Microdochium nivale), rust (Puccinia striiformis, P. graminis, P. recondite, P. hordei), snow blight (Typhula sp., Micronectriella nivalis), loose smut (Ustilago tritici, U. nuda), bunt (Tilletia caries), eyespot (Pseudocercosporella herpotrichoides), scald (Rhynchosporium secalis), leaf blotch (Septoria tritici), glume blotch (Leptosphaeria nodorum) and net blotch (Pyrenophora teres Drechsler);

Citrus diseases: melanose (Diaporthe citri), scab (Elsinoe fawcetti), green mold (Penicillium digitatum) and blue mold (Penicillium italicum);

Apple diseases: blossom blight (Monilinia mali), canker (Valsa ceratosperma), powdery mildew (Podosphaera leucotricha), Alternaria leaf spot (Alternaria alternata apple pathotype), scab (Venturia inaequalis), bitter rot (Colletotrichum acutatum) and late blight (Phytophtora cactorum);

Pear diseases: scab (Venturia nashicola, V. pirina), black spot (Alternaria alternata Japanese pear pathotype), rust (Gymnosporangium asiaticum) and late blight (Phytophtora cactorum);

Peach diseases: brown rot (Monilinia fructicola), scab (Cladosporium carpophilum) and Phomopsis rot (Phomopsis sp.);

Grapes diseases: anthracnose (Elsinoe ampelina), ripe rot (Glomerella cingulata), powdery mildew (Uncinula necator), rust (Phakopsora ampelopsidis), black rot (Guignardia bidwellii), downy mildew (Plasmopara viticola) and Gray mold (Botrytis cinerea);

Diseases of Japanese persimmon: anthracnose (Gloeosporium kaki) and leaf spot (Cercospora kaki, Mycosphaerella nawae);

Diseases of gourd family: anthracnose (Colletotrichum lagenarium), powdery mildew (Sphaerotheca fuliginea), gummy stem blight (Mycosphaerella melonis), Fusarium wilt (Fusarium oxysporum), downy mildew (Pseudoperonospora cubensis), Phytophthora rot (Phytophthora sp.), gray mold fungus (Botrytis cinerea) and damping-off (Pythium sp.);

Tomato diseases: early blight (Alternaria solani), leaf mold (Cladosporium fulvum) and late blight (Phytophthora infestans);

Egg plant disease: brown spot (Phomopsis vexans) and powdery mildew (Erysiphe cichoracearum);

Diseases of Cruciferous Vegetables: Alternaria leaf spot (Alternaria japonica), white spot (Cercosporella brassicae), clubroot (Plasmodiophora brassicae), and downy mildew (Peronospora parasitica);

Rapeseed diseases: Sclerotinia rot (Sclerotinia sclerotiorum), black spot (Alternaria brassicae), powdery mildew (Erysiphe cichoracearum), blackleg (Leptosphaeria maculans);

Welsh onion diseases: rust (Puccinia allii);

Soybean diseases: purple seed stain (Cercospora kikuchii), Sphaceloma scad (Elsinoe glycines), pod and stem blight (Diaporthe phaseolorum var. sojae), rust (Phakopsora pachyrhizi) and phytophthora stem rot (Phytophthora sojae);

Adzuki-bean diseases: Gray mold (Botrytis cinerea), Sclerotinia rot (Sclerotinia sclerotiorum);

Kidney bean diseases: Gray mold (Botrytis cinerea), Sclerotinia rot (Sclerotinia sclero tiorum), anthracnose (Colletotrichum lindemthianum);

Peanut diseases: leaf spot (Cercospora personata), brown leaf spot (Cercospora arachidicola) and southern blight (Sclerotium rolfsii);

Garden pea diseases: powdery mildew (Erysiphe pisi);

Potato diseases: early blight (Alternaria solani) and late blight (Phytophthora infestans);

Strawberry diseases: powdery mildew (Sphaerotheca humuli);

Tea diseases: net blister blight (Exobasidium reticulatum), white scab (Elsinoe leucospila), gray blight (Pestalotiopsis sp.) and anthracnose (Colletotrichum theaesinensis);

Cotton diseases: fusarium wilt (Fusarium oxysporum), damping-off (Rhizoctonia solani);

Tabacco diseases: brown spot (Alternaria longipes), powdery mildew (Erysiphe cichoracearum), anthracnose (Colletotrichum tabacum), downy mildew (Peronospora tabacina) and late blight (Phytophthora nicotianae);

Sugar beet diseases: Cercospora leaf spot (Cercospora beticola), leaf blight (Thanatephorus cucumeris), Root rot (Thanatephorus cucumeris), Aphanomyces root rot (Aphanidermatum cochlioides);

Rose diseases: black spot (Diplocarpon rosae) and powdery mildew (Sphaerotheca pannosa);

Chrysanthemum diseases: leaf blight (Septoria chrysanthemi-indici) and white rust (Puccinia horiana);

Various plants diseases: diseases caused by Pythium spp. (Pythium aphanidermatum, Pythium debarianum, Pythium graminicola, Pythium irregulare, Pythium ultimum), Gray mold (Botrytis cinerea), Sclerotinia rot (Sclerotinia sclerotiorum);

Japanese radish diseases: Alternaria leaf spot (Alternaria brassicicola);

Turfgrass diseases: dollar spot (Sclerotinia homeocarpa), brown patch and large patch (Rhizoctonia solani); and

Banana diseases: Sigatoka disease (Mycosphaerella fijiensis, Mycosphaerella musicola, Pseudocercospora musae).

Examples of the plants to which the composition of the present invention can be applied are as follows:

Crops: corn, rice, wheat, barley, rye, oat, sorghum, cotton, soybean, adzuki-bean, kidney bean, peanut, buckwheat, beet, rapeseed, sunflower, sugar cane, and tobacco, etc.;

Vegetables: solanaceous vegetables (eggplant, tomato, pimento, pepper, and potato, etc.), cucurbitaceous vegetables (cucumber, pumpkin, zucchini, water melon, melon, and squash, etc.), cruciferous vegetables (Japanese radish, white turnip, horseradish, kohlrabi, Chinese cabbage, cabbage, leaf mustard, broccoli, and cauliflower, etc.), asteraceous vegetables (burdock, crown daisy, artichoke, and lettuce, etc.), liliaceous vegetables (welsh onion, onion, garlic, and asparagus), ammiaceous vegetables (carrot, parsley, celery, and parsnip, etc.), chenopodiaceous vegetables (spinach, and Swiss chard, etc.), lamiaceous vegetables (Perilla frutescens, mint, and basil, etc.), strawberry, sweet potato, Japanese yam, and taro, etc.;

Flowers;

Foliage plants;

Turfgrass;

Fruits: pomaceous fruits (apple, pear, Japanese pear, Chinese quince, and quince, etc.), stone fleshy fruits (peach, plum, nectarine, Japanese apricot, cherry fruit, apricot, and prune, etc.), citrus fruits (Citrus unshiu, orange, lemon, lime, and grapefruit, etc.), nuts (chestnut, walnuts, hazelnuts, almond, pistachio, cashew nuts, and macadamia nuts, etc.), berrys (blueberry, cranberry, blackberry, and raspberry, etc.), grape, kaki persimmon, olive, Japanese plum, banana, coffee, date palm, and coconuts, etc.; and

Trees other than fruit trees: tea, mulberry, flowering plant, roadside trees (ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate), etc.

The aforementioned “plants” include plants which resistances have been imparted by genetic recombination.

Exemplary embodiments of the composition of the present invention are as follows:

a composition comprising the present amide compound and benomyl wherein the weight ratio of the present amide compound to benomyl is from 0.0125/1 to 500/1;

a composition comprising the present amide compound and benomyl wherein the weight ratio of the present amide compound to benomyl is from 0.025/1 to 100/1;

a composition comprising the present amide compound and benomyl wherein the weight ratio of the present amide compound to benomyl is from 0.1/1 to 10/1;

a composition comprising the present amide compound and carbendazim wherein the weight ratio of the present amide compound to carbendazim is from 0.0125/1 to 500/1;

a composition comprising the present amide compound and carbendazim wherein the weight ratio of the present amide compound to carbendazim is from 0.025/1 to 100/1; and

a composition comprising the present amide compound and carbendazim wherein the weight ratio of the present amide compound to carbendazim is from 0.1/1 to 10/1.

The method for controlling a plant disease of the present invention (hereinafter, referred to as the method for controlling of the present invention) comprises applying an effective amount in total of the present amide compound and the present fungicidal compound(s) to the plants or the soil for cultivating the plant. Such plants include foliages of plant, seeds of plant, or bulbs of plant. The bulbs herein are intended to mean bulb, corm, rootstock, tuber, tuberous root and rhizophore.

In the method for controlling of the present invention, the present amide compound and the present fungicidal compound(s) may be applied separately around the same time to the plant or the soil for cultivating the plant, but is usually applied as the composition of the present invention because of a convenience on applying.

In the method for controlling of the present invention, examples of the method of applying the present amide compound and the present fungicidal compound(s) include foliage treatment, soil treatment, root treatment and seed treatment.

Such foliage treatment includes for example, a method of applying the composition of the present invention to a surface of the plant to be cultivated by a foliage application or a stem application.

Such root treatment includes a method of soaking whole or a root of the plant into a medicinal solution comprising the present amide compound and the present fungicidal compound(s), and a method of attaching a solid formulation comprising the present amide compound, the present fungicidal compound(s) and the solid carrier to a root of the plant.

Such soil treatment includes soil broadcast, soil incorporation, and irrigation of the medicinal solution to a soil.

Such seed treatment includes an applying of the composition of the present invention to a seed or a bulb of the plant to be prevented from the plant disease, specifically, a spray treatment by spraying a suspension of the composition of the present invention in a mist form to a surface of a seed or a surface of a bulb, a smear treatment by smearing the wettable powder, the emulsifiable concentrate or the flowable formulation of the composition of the present invention with an addition of small amounts of water or as itself to a seed or a bulb, an immerse treatment of a seed into a solution of the composition of the present invention for a given time, a film-coating treatment, and a pellet-coating treatment.

Each dose of the present amide compound and the present fungicidal compound(s) in the method for controlling of the present invention may vary depending on a kind of plant to be treated, a kind or a frequency of an occurrence of a plant disease as a control subject, a dosage form, a treatment period, a treatment method, a treatment site, a climate condition, etc. In case of an application to a foliage of the plant or a soil for cultivating the plant, a total amount of the present amide compound and the present fungicidal compound(s) is usually 1 to 500 g, preferably 2 to 200 g, and more preferably 10 to 100 g, per 1000 m². Each dose of the present amide compound and the present fungicidal compound(s) in the treatment for seed is usually 0.001 to 10 g, and preferably 0.01 to 1 g, per 1 kg of seeds as a total amount of the present amide compound and the present fungicidal compound(s).

The emulsifiable concentrate, the wettable powder or the flowable formulation, etc., is usually applied by diluting them with water, and then spreading them. In this case, usually, each concentration of the present amide compound and the present fungicidal compound(s) contains 0.0005 to 2% by weight, and preferably 0.005 to 1% by weight of the present amide compound and the present fungicidal compound(s) in'total. The dust formulation or the granular formulation, etc, is usually applied as itself without diluting them.

### EXAMPLES

Next, the present invention is described in more detail below by the following examples including formulation examples and test examples, but the present invention should not be construed to be limited thereto.

The formulation examples are given below. It is to be noted that in the formulation examples, the term “part” indicates “part by weight”.

Formulation 1

5 parts of the present amide compound, 5 parts of benomyl, 35 parts of the mixture of white carbon and polyoxyethylene alkylether sulfate ammonium salts (weight ratio 1:1), and 55 parts of water are mixed and the resulting solution is then subjected to fine grinding according to wet grinding method, so as to obtain a flowable formulation. The same above operations are carried out using carbendazim instead of benomyl, so as to obtain flowable formulation.

Formulation 2

10 parts of the present amide compound, 5 parts of benomyl and 1.5 parts of sorbitan trioleate are mixed into 28 parts of an aqueous solution that contains 2 parts of polyvinyl alcohol, and the mixed solution is then subjected to fine grinding according to wet grinding method. Thereafter, 45.50 parts of an aqueous solution that contains 0.05 parts of xanthan gum and 0.1 part of aluminum magnesium silicate is added to the resultant, and 10 parts of propylene glycol is further added thereto. The obtained mixture is blended by stirring, so as to obtain the flowable formulation. The same above operations are carried out using carbendazim instead of benomyl, so as to obtain flowable formulation.

Formulation 3

10 parts of the present amide compound, 40 parts of benomyl, 3 parts of calcium lignosulfonate, 2 parts of sodium lauryl sulfate, and 45 parts of synthetic hydrous silicon oxide are fully crushed and mixed, so as to obtain wettable powders. The same above operations are carried out using carbendazim instead of benomyl, so as to obtain wettable powders.

The test examples are given below.

### Test Examples 1 to 4

True leaf of cucumber was punched out with cork borer to 13 mm in diameter to prepare a leaf disk. In 24 well microwell plate that was dispensed with 1 ml 0:8% water agar, the leaf disk was placed such that the upper side of the leaf was in an upward direction. Thereto was added 20 micro liter a testing solution prepared by mixing a dimethyl sulfoxide solution of the present amide compound and a dimethyl sulfoxide solution of benomyl or carbendazim to a predetermined concentration to treat the leaf disk.

After confirming that the testing medical solution was dried, conidium of gray mold fungus (Botrytis cinerea) was suspended into potato dextrose broth (DIFCO) in a density of about 10⁵ conidia/mL and was then subjected to a spray inoculation. After leaving to stand the leaf disk in a growth chamber set up at 15° C. for four days, an onset area on each leaf was measured and then calculated an onset area rate (hereinafter, referred to as an onset area rate belonging to treated group).

The same operation was carried out with 20 micro liter water instead of 20 micro liter the testing medicine solution to calculate an onset area rate (hereinafter, referred to an onset area rate belonging to non-treated group).

A preventive value was calculated from the above onset area rate belonging to treated group and the onset area rate belonging to non-treated group by the following equation:

Preventive value(%)=100×(A−B)/A

wherein

A: an onset area rate belonging to non-treated group

B: an onset area rate belonging to treated group

onset area rate=(onset area of the leaf disk)/(the total area of the leaf disk)

The results are shown in Tables 1 and 2.

TABLE 1

| | treatment concentration (ppm) | | |
|---|---|---|---|
| Ex. | the present | | preventive |
| No. | amide compound | benomyl | value (%) |
| 1 | 2.5 | 0.5 | 100 |
| 2 | 1.0 | 5.0 | 100 |

TABLE 2

| | treatment concentration (ppm) | | |
|---|---|---|---|
| Ex. | the present | | preventive |
| No. | amide compound | carbendazim | value (%) |
| 3 | 2.5 | 0.5 | 100 |
| 4 | 1.0 | 5.0 | 100 |

Next, the reference examples are given below.

### Reference Examples 1 to 6

For comparison, the same operations as described in Test Examples 1 to 4 were carried out except that the testing medicine solution was substituted with predetermined concentration of a dimethyl sulfoxide solution of benomyl or carbendazim, so as to calculate a preventive value.

The results are shown in Tables 3, 4 and 5.

TABLE 3

| Ref. Ex. | treatment concentration (ppm) | preventive |
|---|---|---|
| No. | the present amide compound | value (%) |
| 1 | 1.0 | 46 |
| 2 | 2.5 | 55.5 |

TABLE 4

| Ref. Ex. | treatment concentration (ppm) | preventive |
|---|---|---|
| No. | benomyl | value (%) |
| 3 | 0.5 | 47.5 |
| 4 | 5.0 | 56.5 |

TABLE 5

| Ref. Ex. | treatment concentration (ppm) | preventive |
|---|---|---|
| No. | carbendazim | value (%) |
| 5 | 0.5 | 45 |
| 6 | 5.0 | 55.5 |

1. A plant disease controlling composition comprising a compound represented by Formula (1): 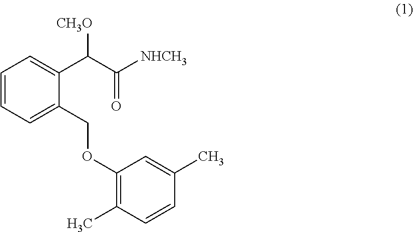
and one or more fungicidal compound(s) selected from Group (A):
Group (A): a group consisting of benomyl and carbendazim.

2. The plant disease controlling composition according to claim 1, wherein the weight ratio of the compound represented by Formula (1) to the fungicidal compound(s) is from 0.0125/1 to 500/1.

3. The plant disease controlling composition according to claim 1 or 2, wherein the compound represented by Formula (1) has R-absolute configuration.

4. A method for controlling a plant disease, wherein the method comprises applying an effective amount in total of a compound of Formula (1): 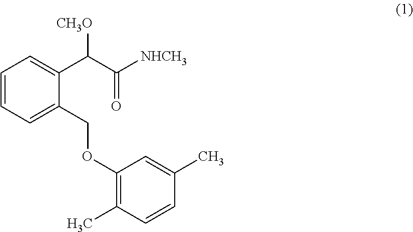
and one or more fungicidal compound(s) selected from Group (A) to a plant or a soil for cultivating the plant,
Group (A): a group consisting of benomyl and carbendazim.

5. The method according to claim 4, wherein the compound of Formula (1) and the fungicidal compound(s) are applied to a seed.

6. The method according to claim 4 or 5, wherein the weight ratio of the compound represented by Formula (1) to the fungicidal compound(s) is from 0.0125/1 to 500/1.

7. The method according to claim 4, wherein the compound represented by Formula (1) has R-absolute configuration.

8. Use of a combination of a compound represented by Formula (1): 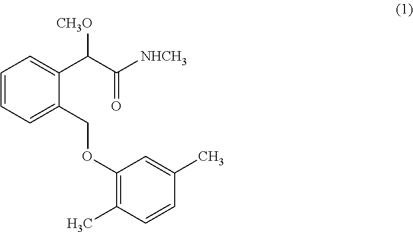
and one or more fungicidal compound(s) selected from Group (A) for controlling a plant disease, Group (A): a group consisting of benomyl and carbendazim.
